(19) United States
(12) Patent Application Publication
(10) Pub. No.: US 2025/0338228 A1
(43) Pub. Date: Oct. 30, 2025

(54) SUBBAND-BASED UPLINK POWER CONTROL

(71) Applicant: QUALCOMM Incorporated, San Diego, CA (US)

(72) Inventors: Morteza SOLTANI, San Diego, CA (US); Yisheng XUE, San Diego, CA (US); Xiaoxia ZHANG, San Diego, CA (US); Jing SUN, San Diego, CA (US); Karoly BECZE, Escondido, CA (US); Junyi LI, Greentown, PA (US); Sam LIU, San Diego, CA (US); Siva Kumar JUJARAY, San Diego, CA (US)

(21) Appl. No.: 18/648,200

(22) Filed: Apr. 26, 2024

(51) Int. Cl. H04W 52/14; H04L 1/00; H04W 52/36; H04W 52/42

(52) U.S. Cl. CPC H04W 52/146; H04L 1/0003; H04W 52/36; H04W 52/42

(57) ABSTRACT

Methods, systems, and devices for wireless communications for a user equipment (UE) are described. The UE may receive an indication of a subband configuration for an operating bandwidth of the UE, the subband configuration indicating a division of the operating bandwidth into multiple subbands. The UE may perform multiple uplink power control procedures for the subbands to obtain subband-specific transmit powers for the subbands. The UE may transmit one or more uplink messages via the subbands using the subband-specific transmit powers obtained from the uplink power control procedures. In some examples, the UE may transmit uplink reference signals via the subbands, and receive, such as from a network entity, an indication of measurements corresponding to the reference signals. The UE may obtain the subband-specific transmit powers based on the measurements.

### FIELD OF TECHNOLOGY

The following relates to wireless communications, including subband-based uplink power control.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving an indication of a subband configuration for an operating bandwidth of the UE, the subband configuration indicating a division of the operating bandwidth into a set of multiple subbands, performing a set of multiple uplink power control procedures for the set of multiple subbands to obtain a set of multiple subband-specific transmit powers for the set of multiple subbands, and transmitting one or more uplink messages via the set of multiple subbands using the set of multiple subband-specific transmit powers obtained from the set of multiple uplink power control procedures.

A UE for wireless communications is described. The UE may include one or more memories storing processor executable code, and one or more processors coupled with the one or more memories. The one or more processors may individually or collectively be operable to execute the code to cause the UE to receive an indication of a subband configuration for an operating bandwidth of the UE, the subband configuration indicating a division of the operating bandwidth into a set of multiple subbands, perform a set of multiple uplink power control procedures for the set of multiple subbands to obtain a set of multiple subband-specific transmit powers for the set of multiple subbands, and transmit one or more uplink messages via the set of multiple subbands using the set of multiple subband-specific transmit powers obtained from the set of multiple uplink power control procedures.

Another UE for wireless communications is described. The UE may include means for receiving an indication of a subband configuration for an operating bandwidth of the UE, the subband configuration indicating a division of the operating bandwidth into a set of multiple subbands, means for performing a set of multiple uplink power control procedures for the set of multiple subbands to obtain a set of multiple subband-specific transmit powers for the set of multiple subbands, and means for transmitting one or more uplink messages via the set of multiple subbands using the set of multiple subband-specific transmit powers obtained from the set of multiple uplink power control procedures.

A non-transitory computer-readable medium storing code for wireless communications is described. The code may include instructions executable by one or more processors to receive an indication of a subband configuration for an operating bandwidth of the UE, the subband configuration indicating a division of the operating bandwidth into a set of multiple subbands, perform a set of multiple uplink power control procedures for the set of multiple subbands to obtain a set of multiple subband-specific transmit powers for the set of multiple subbands, and transmit one or more uplink messages via the set of multiple subbands using the set of multiple subband-specific transmit powers obtained from the set of multiple uplink power control procedures.

Some examples of the method, UEs, and non-transitory computer-readable medium described herein may further include operations, features, means, or instructions for receiving instructions to perform subband-based power control for uplink, where the set of multiple uplink power control procedures may be performed based on the instructions to perform subband-based power control for uplink.

In some examples of the method, UEs, and non-transitory computer-readable medium described herein, performing the set of multiple uplink power control procedures may include operations, features, means, or instructions for transmitting a set of multiple uplink reference signals via the set of multiple subbands, receiving, from a network entity, an indication of a set of multiple measurements corresponding to the set of multiple reference signals (e.g., uplink reference signals), and obtaining the set of multiple subband-specific transmit powers for the set of multiple subbands based on the set of multiple measurements.

In some examples of the method, UEs, and non-transitory computer-readable medium described herein, receiving the indication of the set of multiple measurements may include operations, features, means, or instructions for receiving a set of multiple offsets for the set of multiple subbands, where the set of multiple subband-specific transmit powers may be based on the set of multiple offsets.

In some examples of the method, UEs, and non-transitory computer-readable medium described herein, receiving the indication of the set of multiple measurements may include operations, features, means, or instructions for receiving, for the set of multiple subbands, a set of multiple offsets relative to a baseline offset, where the set of multiple subband-specific transmit powers may be based on the set of multiple offsets and the baseline offset.

In some examples of the method, UEs, and non-transitory computer-readable medium described herein, the set of multiple measurements includes a set of multiple pathloss measurements corresponding to the set of multiple subbands and includes one or more parameters corresponds to the set of multiple subbands, the one or more parameters corresponding to subband-specific pathloss measurements associated with the network entity.

In some examples of the method, UEs, and non-transitory computer-readable medium described herein, receiving indication of the subband configuration may include operations, features, means, or instructions for receiving a quantity of subbands, an upper frequency of one or more of the set of multiple subbands, a lower frequency of one or more of the set of multiple subbands, a relative location of one or more of the set of multiple subbands based on one or more resources, one or more optical wireless communication (OWC) parameters of a network entity, one or more OWC parameters of the UE, or any combination thereof.

Some examples of the method, UEs, and non-transitory computer-readable medium described herein may further include operations, features, means, or instructions for transmitting a set of multiple uplink reference signals via the set of multiple subbands and receiving, from a network entity, an indication of a set of multiple uplink pathloss measurements corresponding to the set of multiple uplink reference signals (e.g., uplink reference signals), where performing the set of multiple uplink power control procedures includes transmitting multiple uplink reference signals, receiving an indication of multiple measurements corresponding to the uplink reference signals, and obtaining subband-specific transmit powers for the subbands based on the measurements.

In some examples of the method, UEs, and non-transitory computer-readable medium described herein, the mapping may be specific to an uplink communication link direction.

Some examples of the method, UEs, and non-transitory computer-readable medium described herein may further include operations, features, means, or instructions for mapping the set of multiple subbands to a set of multiple modulation and coding scheme (MCS) index factors, receiving an indication identifying one or more subbands of the set of multiple subbands, and transmitting one or more additional uplink messages via the identified one or more subbands of the set of multiple subbands based on one or more corresponding MCS factors of the set of multiple MCS factors.

Some examples of the method, UEs, and non-transitory computer-readable medium described herein may further include operations, features, means, or instructions for mapping the set of multiple subbands to a set of multiple resource block factors, receiving an indication identifying one or more subbands of the set of multiple subbands, and transmitting one or more additional uplink messages via the identified one or more subbands of the set of multiple subbands based on one or more corresponding resource block factors of the set of multiple resource block factors.

Some examples of the method, UEs, and non-transitory computer-readable medium described herein may further include operations, features, means, or instructions for receiving, from a network entity, a first indication of one or more target receive powers for the network entity, mapping the set of multiple subbands to the one or more target receive powers, receiving a second indication identifying one or more subbands of the set of multiple subbands, and transmitting one or more additional uplink messages via the identified one or more subbands based on the one or more target receive powers.

Some examples of the method, UEs, and non-transitory computer-readable medium described herein may further include operations, features, means, or instructions for mapping the set of multiple subbands to a set of multiple power control parameters, receiving an indication identifying one or more subbands of the set of multiple subbands, and transmitting one or more additional uplink messages via the identified one or more subbands of the set of multiple subbands based on a corresponding one or more power control parameters of the set of multiple power control parameters.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports subband-based uplink power control in accordance with one or more aspects of the present disclosure.

FIG. 2 shows an example of a wireless communications system that supports subband-based uplink power control in accordance with one or more aspects of the present disclosure.

FIG. 3 shows an example of a process flow diagram that supports subband-based uplink power control in accordance with one or more aspects of the present disclosure.

FIGS. 4 and 5 show block diagrams of devices that support subband-based uplink power control in accordance with one or more aspects of the present disclosure.

FIG. 6 shows a block diagram of a communications manager that supports subband-based uplink power control in accordance with one or more aspects of the present disclosure.

FIG. 7 shows a diagram of a system including a device that supports subband-based uplink power control in accordance with one or more aspects of the present disclosure.

FIGS. 8 and 9 show flowcharts illustrating methods that support subband-based uplink power control in accordance with one or more aspects of the present disclosure.

### DETAILED DESCRIPTION

Some wireless communications systems may support optical wireless communication (OWC) to transmit or receive information. Some OWC systems may operate in an optical spectrum between approximately 1011 and 1016 hertz (Hz). For example, the first device may transmit an optical wireless signal (e.g., a signal in the infrared to ultraviolet spectrum) to a second device via a beam of light using a light source. The second device may receive the optical wireless sign using a photodetector. One or more light sources or photodetectors may be referred to as an optical front end (OFE) of a device. Some optical channels may offer relatively little or no fading, while tending to increasingly attenuate signals with increasing frequency. The attenuation characteristic may be referred to as a “low-pass” characteristic, where signals in a relatively lower band may exhibit little or no attenuation, while some relatively higher-frequency signals may be increasingly attenuated as the frequency increases.

Accordingly, pathloss for OWC channels, and similar frequency ranges, may be frequency dependent. Pathloss may be dependent on various parameters, such as the relative distance between the network entity and the UE, center frequency, shadow-fading, and pathloss exponent, among other factors. In radio frequency (RF) systems, if a user equipment (UE) is relatively static, the surrounding environment is static, and the UE is operating on a fixed center frequency, the pathloss may not change frequently or may stay within a given range. However, in OWC or other similar frequencies, the channel is non-fading and may present low-pass behavior. Thus, even if the UE and environment are static, the pathloss may be different for different bandwidths, subcarriers, or frequencies. Further, pathloss for uplink and downlink communications may not be the same across frequencies. That is, pathloss may differ depending on communication direction (e.g., uplink or downlink).

Techniques described herein enable subband-based uplink power control procedures to determine transmit power for uplink communications. A network entity may divide the operational bandwidth for downlink and uplink into subbands, and the network entity may indicate the division to the UE. The network entity may configure (e.g., instruct) the UE to perform a subband-based power control process that may include determining (e.g., obtaining, calculating) pathloss for each subband, and determining a transmit power based on the pathloss for each subband. The UE may transmit one or more uplink messages using the subband-specific transmit power determined for each subband.

In some examples, the UE may receive information for the power control process from the network entity, such as additional configurations, measurements, and subband indications. For example, the UE may transmit reference signals to the network entity. The network entity may perform uplink pathloss measurements based on the reference signals from the UE, and indicate the measurements to the UE. The UE may use the uplink pathloss measurements performed by the network entity to determine (e.g., calculate, obtain) transmit powers for the subbands.

Aspects of the disclosure are initially described in the context of wireless communications systems and a process flow diagram. Aspects of the disclosure are further illustrated by and described with reference to apparatus diagrams, system diagrams, and flowcharts that relate to subband-based uplink power control.

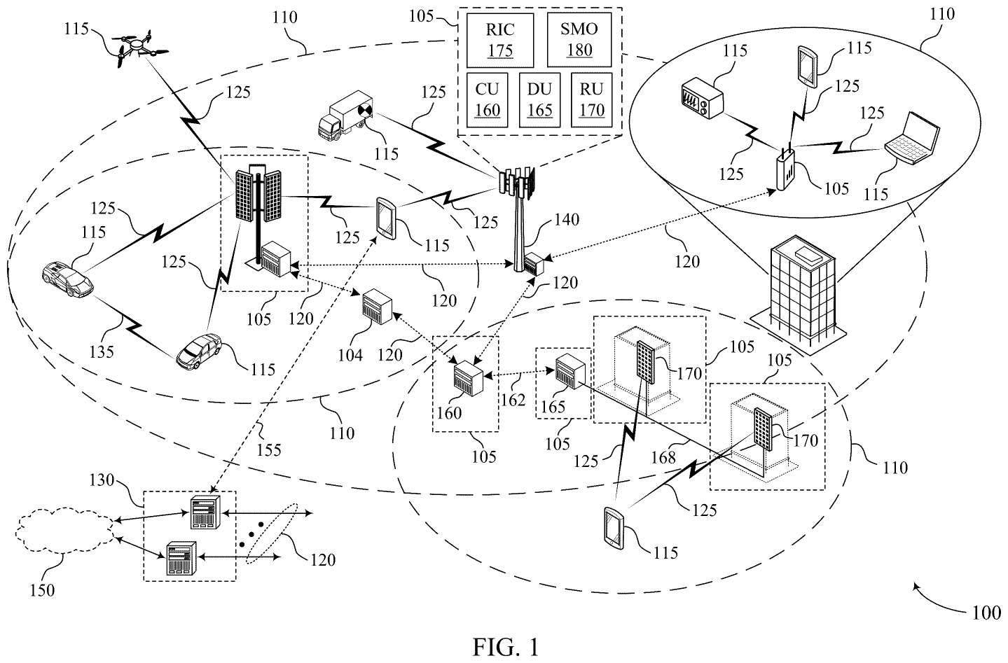

FIG. 1 shows an example of a wireless communications system 100 that supports subband-based uplink power control in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a RF access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-cNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The network entity 105 and the UE 115 may communicate via an OWC. Some OWC systems may operate in an optical spectrum between approximately 1011 and 1016 hertz (Hz). For example, the transmitting device (e.g., UE 115, network entity 105) may transmit an optical wireless signal (e.g., a signal in the infrared to ultraviolet spectrum) to the receiving device (e.g., UE 115, network entity 105) via a beam of light using a light source. The receiving device may receive the optical wireless sign using a photodetector. One or more light sources or photodetectors may be referred to as an OFE of a device. Some optical channels may offer relatively little or no fading, while tending to increasingly attenuate signals with increasing frequency. The attenuation characteristic may be referred to as a “low-pass” characteristic. Pathloss for OWC channels, and similar frequency ranges, may be frequency dependent. Thus, even if the UE 115 and environment are static, the pathloss may be different for different bandwidths. Additionally, pathloss for uplink and downlink communications may not be consistent across frequencies.

Techniques described herein provide for subband-based uplink power control procedures to determine transmit power for uplink communications. The network entity 105 may divide the operational bandwidth for downlink and uplink into subbands, and indicate the division to the UE 115. The network entity 105 may configure the UE 115 with a subband-based power control process that may include determining (e.g., obtaining, calculating) pathloss for each subband, and determining a transmit power based on the pathloss for each subband. The UE 115 may transmit one or more uplink messages using the subband-specific transmit power determined for each subband.

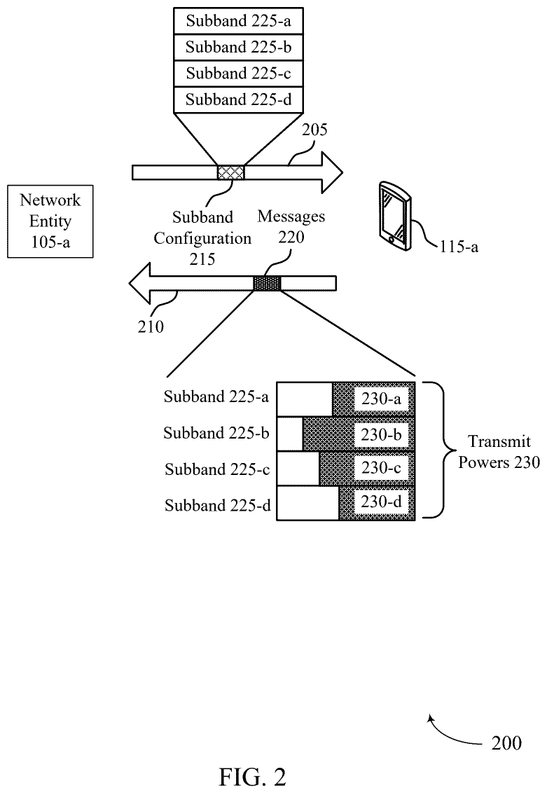

In some examples, the UE 115 may receive information for the power control process from the network entity 105, such as additional configurations, measurements, and subband indications. For example, the UE 115 may transmit reference signals (e.g., uplink reference signals) to the network entity. The network entity 105 may perform uplink pathloss measurements based on the reference signals from the UE 115, and indicate the measurements to the UE 115. The UE 115 may use the uplink pathloss measurements performed by the network entity to determine (e.g., calculate, obtain) transmit powers for the subbands. Techniques are further described herein with reference to FIGS. 2-9.

FIG. 2 shows an example of a wireless communications system 200 that supports subband-based uplink power control in accordance with one or more aspects of the present disclosure. The wireless communications system 200 describes the communications between a UE 115-a and a network entity 105-a. In some examples, aspects of the wireless communications system 200 may implement or be implemented by aspects of the wireless communications system 100. For example, the wireless communications system 200 may include the UE 115-a and the network entity 105-a, which may be examples of the corresponding devices as described herein, including with reference to FIG. 1.

The network entity 105-a may indicate a subband configuration 215 to the UE 115-a via a communication link 205 (e.g., uplink). The subband configuration 215 may include an indication of a division of subbands 225. The subbands 225 may include one or more subbands 225, such as a subband 225-a, a subband 225-b, a subband 225-c, a subband 225-d. The UE 115-a may receive the subband configuration 215, determine one or more subband-specific transmit powers 230, and transmit one or more messages 220 according to the transmit powers 230. The transmit powers 230 may be specific to each subband 225. For example, the subband 225-a may have a transmit power 230-a, the subband 225-b may have a transmit power 230-b, the subband 225-c may have a transmit power 230-c, and the subband 225-d may have a transmit power 230-d. The UE 115-a may transmit the messages 220 via a communication link 210 (e.g., downlink).

In some examples, the UE 115-a and the network entity 105-a may support OWC communications. For example, the UE 115-a and the network entity 105-a may transmit optical signals, such as beams of light, via an OWC link. The communication link 205 and the communication link 210 may be examples of OWC links, via which optical signals may be communicated. As used herein, the term “communication” and variations thereof may denote transmission, reception, or a combination thereof.

The network entity 105-a may communicate an optical wireless signal with the UE 115-a via a beam of light, which may be received and measured using optical components of the UE 115-a or network entity 105-a. Optical components of the UE 115-a or network entity 105-a may be used to transmit or receive an optical wireless signal. Optical components may include, for example, one or more photodetectors, lenses, or mirrors (e.g., condenser lenses, concave mirrors, or reflectors that may focus the optical wireless signal towards one or more photodetectors). Additionally, or alternatively, the optical components may include one or more light sources, lenses, or mirrors (e.g., condenser lenses, concave mirrors, or reflectors that may collimate optical wireless signals emitted or output by the one or more light sources). One or more optical components or a combination of optical components (e.g., a combination of one or more lenses, one or more mirrors, one or more photodetectors, or one or more light sources, among other examples) may be referred to as an OFE. The UE 115-a may include one or more OFEs or the network entity 105-a may include one or more OFEs.

In some wireless communication systems, the UE 115-a and the network entity 105-a may communicate information via one or more optical signals (e.g., variations in light intensity) in an optical band or via one or more electromagnetic signals (e.g., variations in voltage) in an radio frequency band. For example, the UE 115-a and the network entity 105-a may communicate information using optical signals in a frequency band of (approximately) 10¹¹ to 10¹⁶ Hz, such as in the infrared to ultraviolet spectrum. Additionally, or alternatively, the UE 115-a and the network entity 105-a may communicate information using electromagnetic signals in a frequency band of (approximately) 10¹ to 10¹² Hz.

Some OWC systems may operate in an optical spectrum between approximately 10¹¹ and 10¹⁶ Hz. OWC may be envisioned to provide a relatively high data rate, such as 1 Tbps per link, because it may be difficult to support a 1 Tbps link using a range of RF (e.g., 100 GHz) spectrum. For instance, 1 Tbps communications may be targeted for 6G or 7G data rates.

Observations or measurements may demonstrate distortions resulting from device non-idealities (e.g., optical-to-electrical conversion nonlinearities or diode nonlinearities). For instance, frequency selective transmission side-originated distortions may include nonlinearities induced by electrical-to-optical conversions or a light source (e.g., light emitting diode (LED) or laser diode (LD)). In addition to transmission side-originated distortions, a photodetector (e.g., APD or SiPM) may introduce receive side-originated distortions.

Some optical channels may offer relatively little or no fading, while tending to increasingly attenuate signals with increasing frequency. The attenuation characteristic may be referred to as a “low-pass” characteristic, where signals in a relatively lower band may exhibit little or no attenuation, while some relatively higher-frequency signals may be increasingly attenuated as the frequency increases. In one example of a low-pass channel, in relatively lower frequency bands (e.g., in a 200 to 800 MHz range), a degradation of less than 2 dB per 100 MHz may occur. In higher frequency bands (e.g., 800 to 2000 MHz), a loss greater than 4 dB may occur per 100 MHz. Thus, degradation, or pathloss, may be frequency dependent.

An OWC channel frequency response may be a combination of a light source (e.g., LED or LD) frequency response, an optical wireless channel, and a photodetector frequency response. Light source and photodetector frequency responses may be relatively stable (e.g., may be static or may not change often).

Pathloss for OWC channels, or other channels in similar frequency ranges, may be link direction dependent. For example, pathloss for OWC uplink channels and pathloss for OWC downlink channels may be different. Downlink OWC channel behavior may be different from uplink OWC channel due to the operating point (e.g., DC bias), which may affect the LED or LD frequency response or the photodetector frequency response. Uplink OWC channel communications may be affected by the LED or LD frequency response at the UE 115-a and the photodetector frequency response at the network entity 105-a. Similarly, downlink OWC channel communications may be affected by the LED or LD frequency response at the network entity 105-a and the photodetector frequency response at the UE 115-a. Thus, for uplink transmit power calculations, frequency-dependent pathloss may be a significant factor.

Uplink power control may be used to determine the transmit power for a transmission, such as for physical uplink shared channel (PUSCH), physical uplink control channel (PUCCH), sounding reference signal (SRS), and physical random access channel (PRACH) transmissions. Power control may reduce intra-cellular interference, inter-cellular interference, and UE 115-a power consumptions. Power control may be based on pathloss. The UE 115-a may maintain multiple (e.g., 4) path loss estimates for uplink transmissions, such as for NR applications. The transmit power of the UE 115-a may be based on multiple factors, including the target receiving power set by the network entity 105-a, a pathloss factor, a modulation and coding scheme (MCS) factor, a resource block factor, and a power control command. The target receiving power set by the network entity 105-a may be a target base power for transmissions, or a threshold power that allows for safe decoding at the network entity 105-a. The pathloss factor may be the pathloss between the UE 115-a and the network entity 105-a, which may be calculated by determining the difference between the reference signal power and the reference signal power measured by the UE 115-a. The MCS factor may be transmission power determined by the MCS value. The resource block power may be a transmission power determined by the number (e.g., quantity) of transmitted resource blocks. The power control command may be a transmission power determined by the network entity 105-a.

Power control may be designated as open loop, such as for a PRACH transmission, or closed loop, such as for PUSCH transmissions. Open loop and closed loop power control may have different factors applicable for determining the transmission power at the UE 115-a. In both open and closed loop power control, pathloss may be a relevant factor.

Pathloss for OWC channels, and similar frequency ranges, may be frequency dependent. Pathloss may be dependent on various parameters, such as the relative distance between the network entity 105-a and the UE 115-a, center frequency, shadow-fading, and pathloss exponent, among other factors. In RF systems, such as 5G or 6G systems, if the UE 115-a is relatively static, the surrounding environment is static, and the UE 115-a is operating on a fixed center frequency, the pathloss may not change frequently or drastically. However, in OWC systems or other similar frequencies, the channel is non-fading and may present low-pass behavior. Thus, even if the UE 115-a and environment are static, the pathloss may be different for different bandwidths. For example, a UE 115-a that switches from one operating bandwidth to another but doesn't change other related parameters, may have a significantly different pathloss due to the bandwidth switch. In some examples, multiple UEs 115 operating with the same component carrier, similar relative distances to the network entity 105-a, and similar optical front ends, but configured with different bandwidths may have different pathlosses (e.g., the pathloss may be frequency dependent). Similarly, uplink transmissions for OWC and similar frequency applications may be subject to frequency-selective pathloss.

Pathloss for OWC channels, and similar frequency ranges, may be link-direction dependent. That is, pathloss may be different for uplink and downlink. Generally, such as for RF and 5G NR systems, the difference between the pathloss of the downlink and uplink may be a constant gap and not dependent on frequency. In RF, both the downlink and uplink pathloss are not dependent on frequency, and have a constant gap between the uplink pathloss and the downlink pathloss. The gap may be based on the power amplifier, AGC, cable loss, etc. The gap between the uplink and downlink pathloss may be compensated by a power offset and power ramping in PRACH. In RF, the same antennas are used for transmission and reception. However, in OWC, the downlink pathloss and uplink pathloss may not have a consistent gap.

Further, For OWC applications, the downlink transmission is transmitted via the LED/LD of the network entity 105-a, but uplink reception is received by the photodetector of the network entity 105-a. There may be a difference between the LED/LD frequency and the photodetector frequency response of the network entity 105-a and of the UE 115-a. The difference may result in varying pathloss between uplink and downlink communications.

Techniques described herein provide for uplink power control for OWC channels and similar frequency applications. The network entity 105-a may divide the operational bandwidth for downlink and uplink into the subbands 225, and indicate the division via the subband configuration 215. The subband configuration 215 may configure the UE 115-a with a subband-based power control process. The subband-based power control process may include determining (e.g., obtaining, calculating) different pathloss measurements or indications to determine different transmit powers 230 for each subband 225. The pathloss may be determined separately for uplink and downlink, such that different uplink transmit powers 230 are applied for each uplink subband.

Pathloss may vary between uplink and downlink, such that the UE 115-a may not rely on downlink pathloss measurements for the messages 220, which may be uplink messages. To receive uplink pathloss measurements to determine the transmit powers 230, the UE 115-a may be configured via the subband configuration 215 to transmit uplink pathloss reference signals. For example, the UE 115-a may transmit an uplink reference signal per subband 225, or may transmit a wideband reference signal. The network entity 105-a may perform uplink pathloss measurements based on the reference signals from the UE 115-a, and indicate the measurements to the UE 115-a. Uplink pathloss measurements performed by the network entity 105-a may be indicated in the form of a per subband offset, or as an addition or adjustment per subband from a baseline offset. The UE 115-a may use the uplink pathloss measurements performed by the network entity 105-a to determine (e.g., calculate, obtain) transmit powers 230 for the subbands 225.

To obtain the transmit powers 230, the UE 115-a may use related configuration parameters for each subband 225. For example, the UE 115-a may use the profile of the OWC channel based on the optical front end of the UE 115-a and the optical front end of the network entity 105-a. The network entity may, such as part of the subband configuration 215, indicate related information for determine the transmit powers 230 to the UE 115-a in addition to the division of the subbands 225.

For example, the network entity 105-a may signal, such as via the subband configuration 215, information about the subband configurations and the optical front end parameters of the network entity 105-a. Information about the subband configurations may include a quantity of the one or more optical subbands associated with the optical channel, an indication of a location in an resource block for at least one of the one or more optical subbands associated with the optical channel, a frequency range, an indication of a first frequency (e.g., a starting or beginning frequency) and a second frequency (e.g., an ending frequency) for at least one of the one or more optical subbands associated with the optical channel. Such information may improve early establishment of the connection between the network entity 105-a and the UE 115-a, such as for PRACH transmissions.

In some examples, the network entity 105-a may indicate, such as via the subband configuration 215, configuration of the UE 115-a with specific subbands and signal information related to the indicated subbands. Such specific information may be application for examples where the connection between the network entity 105-a and the UE 115-a has already been established, such as for PUSCH transmissions.

Each subband 225 may have a specific pathloss measurement for uplink and downlink. The pathloss measurements for each subband 225 for downlink may be measured by the UE 115-a, and the pathloss measurements for each subband 225 for uplink may be measured by the network entity 105-a and indicated to the UE 115-a. Additionally, each subband may have one or more characteristics (e.g., quantity of subbands, frequency widths, modulation and coding schemes (MCSs), modulation orders, transport bock distribution, multiple-input multiple-output (MIMO) layers, or quantities of bits, among other examples) specific to each subband. Allowing different characteristics may allow enhanced communication performance (e.g., data rates) or communication structure flexibility.

The network entity 105-a and the UE 115-a may construct a structure (e.g., table, array, database, list, or tree, among other examples) of mapping between subbands 225 and characteristics of each subband. The network entity 105-a may indicate an index of a subband, or otherwise identify a subband 225, to the UE 115-a. The UE 115-a may identify the corresponding characteristic of the indicated subband 225 based on the mapping, and use the characteristic to determine the transmit power 230 for the indicated subband 225.

For example, the network entity 105-a and the UE 115-a may construct a table containing a mapping between subbands and pathloss measurements. The network entity 105-a may indicate an index for a subband 225 to the UE 115-a for a future transmission. For example, the network entity 105-a may indicate an index for the subband 225-b, and the UE 115-a may determine, or look up, the pathloss mapped to the subband 225-b. The UE may determine the transmit power 230-b for the subband 225-b based on the mapped pathloss. The table may be specific to uplink or specific to downlink, and the UE 115-a may have multiple tables for each link direction.

Further, the network entity 105-a and the UE 115-a may construct tables, or otherwise map, subbands to their receptive characteristics. For example, there may be a mapping between the subbands 225 and MCS factors for each subband, a mapping between the subbands 225 and the resource block factors, a mapping between the subbands and the target reception power set by the network entity, and a mapping between the subbands and the power control command set by the network entity 105-a. The network entity may indicate an index for a subband, and the UE 115-a may use the index to identify the subband the characteristic associated with mapping, and adjust accordingly for future transmissions. For example, the UE 115-a may receive an index for the subband 225-c, and adjust the MCS factor for the transmit power 230 according to the MCS factor mapped to the subband 225-c. Thus, the UE 115-a may base the transmit power 230 on multiple factors relating to the subband 225.

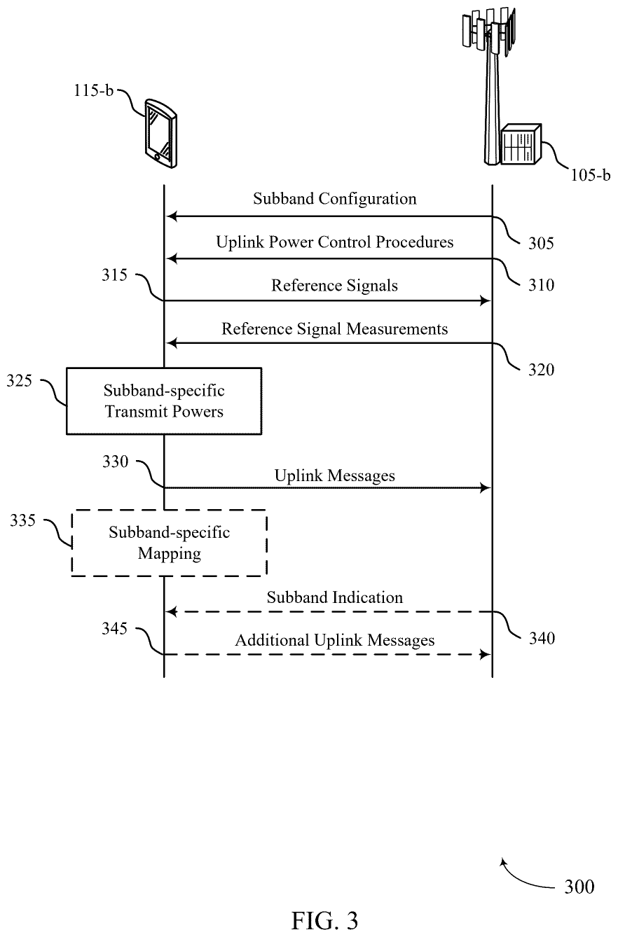

FIG. 3 shows an example of a process flow diagram 300 that supports subband-based uplink power control in accordance with one or more aspects of the present disclosure. In some examples, aspects of the process flow diagram 300 may implement or be implemented by aspects of the wireless communications system 100 or the wireless communications system 200. For example, the process flow diagram 300 may be implemented by a UE 115-b or a network entity 105-b, which may be examples of the corresponding devices as described herein with reference to FIGS. 1 and 2. In the following description of the process flow diagram 300, the operations between the network entity 105-b and the UE 115-b may be performed in a different order than the example order shown. Some operations may also be omitted from the process flow diagram 300, or other operations may be added to the process flow diagram 300. Further, although some operations or signaling may be shown to occur at different times for discussion purposes, these operations may actually occur at the same time.

The UE 115-b may perform a plurality of uplink power control procedures for the plurality of subbands to obtain a plurality of subband-specific transmit powers for the plurality of subbands. For example, steps 315-345 may describe examples of uplink power control procedures.

At 305, the UE 115-b may receive an indication of a subband configuration for an operating bandwidth of the UE 115-b, the subband configuration indicating a division of the operating bandwidth into multiple subbands. In some examples, the subband configuration includes a quantity of subbands, an upper frequency of one or more of the plurality of subbands, a lower frequency of one or more of the plurality of subbands, a relative location of one or more of the subbands based on one or more resources, one or more OWC parameters of a network entity, one or more OWC parameters of the UE 115-b, or any combination thereof. In some examples, the subband configuration may include OFE information of the network entity 105-b.

At 310, the UE 115-b may receive instructions to perform subband-based power control for uplink, where the uplink power control procedures are performed based on the instructions to perform subband-based power control for uplink. Performing the uplink power control procedures (e.g., further described at steps 315-325) may include transmitting multiple uplink reference signals, receiving an indication of multiple measurements corresponding to the uplink reference signals, and obtaining subband-specific transmit powers for the subbands based on the measurements.

At 315, the UE 115-b may transmit multiple uplink reference signals via the multiple subbands. Transmitting the uplink reference signals may be an example of the uplink power control procedures. The uplink reference signals may each correspond to a subband, or may correspond to one or more subbands.

At 320, the UE 115-b may receive, from the network entity 105-b, an indication of measurements corresponding to the reference signals (e.g., uplink reference signals). Receiving the indication of the multiple measurements may include receiving offsets for the subbands, wherein subband-specific transmit powers are based on the offsets. In some examples, receiving the indication of the multiple measurements may include receiving, for the subbands, offsets relative to a baseline offset, where the subband-specific transmit powers are based on the offsets and the baseline offset.

In some examples, the measurements may include pathloss measurements corresponding to the subbands and may include one or more parameters corresponding to the subbands. The one or more parameters may correspond to subband-specific pathloss measurements associated with the network entity 105-b.

At 325, the UE 115-b may obtain (e.g., determine) multiple subband-specific transmit powers for the subbands based on the measurements received from the network entity 105-b. For example, the UE 115-b may perform, based on a mapping between the uplink pathloss measurements and subbands, a first power control procedure for a first subband of the subbands using a first uplink pathloss measurement of the uplink pathloss measurements to obtain a first subband-specific transmit power for the first subband. The UE 115-b may perform, based on the mapping between the uplink pathloss measurements and the subbands, a second power control procedure for a second subband of the subbands using a second uplink pathloss measurement of the f uplink pathloss measurements to obtain a second subband-specific transmit power for the second subband. In some examples, the mapping is specific to an uplink communication link direction.

At 330, the UE 115-b may transmit one or more uplink messages via the subbands using the subband-specific transmit powers obtained from the uplink power control procedures.

At 335, the UE 115-b, the network entity 105-b, or both, may map the subbands to one or more characteristics (e.g., factors, parameters). For example, the subbands may be mapped to MCS factors, resource block factors, one or more target receive powers, power control parameters, or a combination thereof. In some examples, the target receive powers may be signaled by the network entity 105-a. The mapping may be constructed as a table.

At 340, the UE 115-b may receive an indication identifying one or more subbands of the multiple subbands. For example, the network entity 105-b may indicate an MCS index identifying a location of the table.

At 345, the UE 115-b may transmit one or more additional uplink messages via the identified one or more subbands of the subbands based on one or more corresponding characteristics. For example, the UE 115-b may transmit one or more additional uplink messages via the identified one or more subbands of the multiple subbands based on one or more corresponding MCS factors of the multiple MCS factors, based on one or more corresponding resource block factors of the multiple resource block factors, based on the one or more target receive powers, based on a corresponding one or more power control parameters of the multiple power control parameters, or a combination thereof.

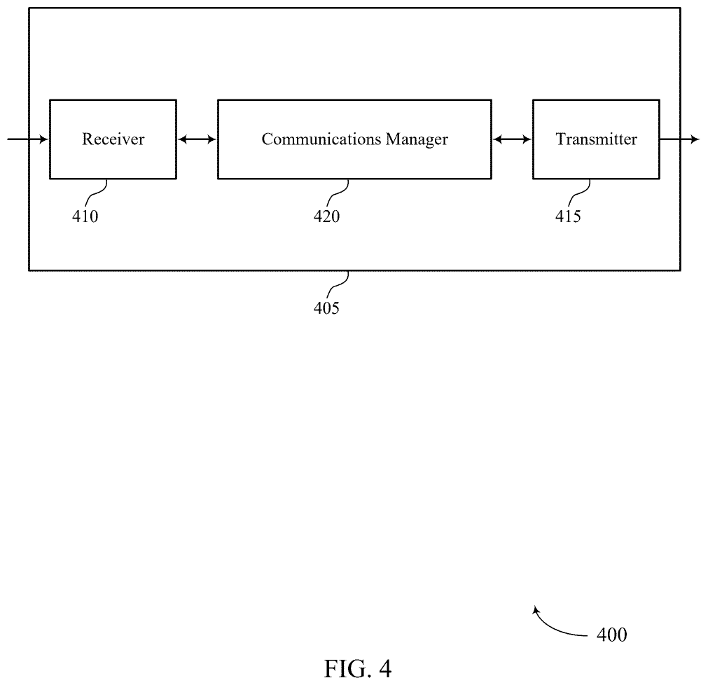

FIG. 4 shows a block diagram 400 of a device 405 that supports subband-based uplink power control in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to subband-based uplink power control). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to subband-based uplink power control). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of subband-based uplink power control as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving an indication of a subband configuration for an operating bandwidth of the UE, the subband configuration indicating a division of the operating bandwidth into a set of multiple subbands. The communications manager 420 is capable of, configured to, or operable to support a means for performing a set of multiple uplink power control procedures for the set of multiple subbands to obtain a set of multiple subband-specific transmit powers for the set of multiple subbands. The communications manager 420 is capable of, configured to, or operable to support a means for transmitting one or more uplink messages via the set of multiple subbands using the set of multiple subband-specific transmit powers obtained from the set of multiple uplink power control procedures.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for subband-based uplink power control, which may result in various advantageous, including reduced processing, reduced power consumption, more efficient utilization of communication resources, etc.

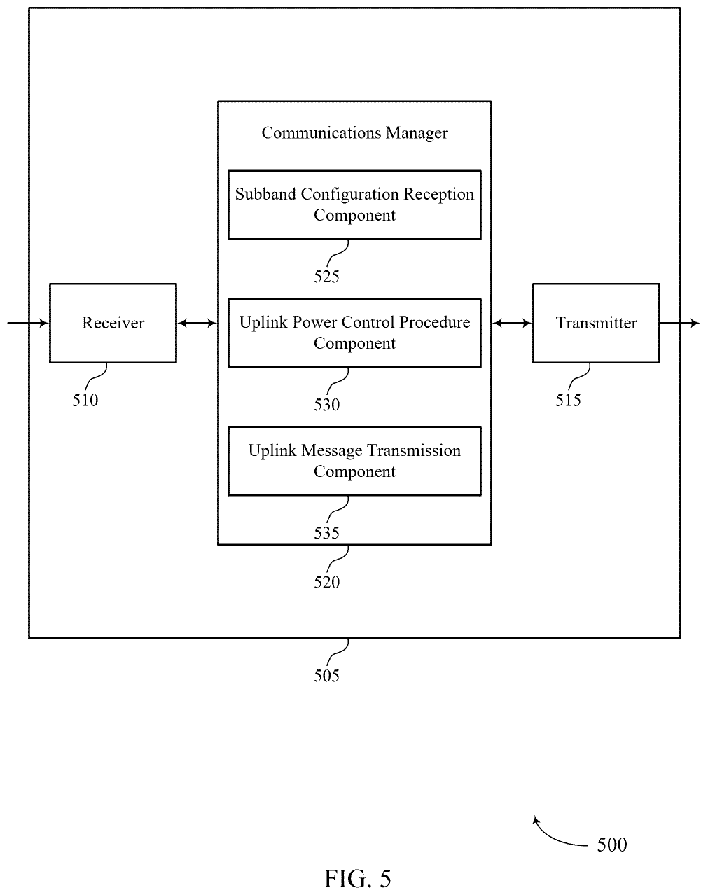

FIG. 5 shows a block diagram 500 of a device 505 that supports subband-based uplink power control in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to subband-based uplink power control). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to subband-based uplink power control). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of subband-based uplink power control as described herein. For example, the communications manager 520 may include a subband configuration reception component 525, an uplink power control procedure component 530, an uplink message transmission component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The subband configuration reception component 525 is capable of, configured to, or operable to support a means for receiving an indication of a subband configuration for an operating bandwidth of the UE, the subband configuration indicating a division of the operating bandwidth into a set of multiple subbands. The uplink power control procedure component 530 is capable of, configured to, or operable to support a means for performing a set of multiple uplink power control procedures for the set of multiple subbands to obtain a set of multiple subband-specific transmit powers for the set of multiple subbands. The uplink message transmission component 535 is capable of, configured to, or operable to support a means for transmitting one or more uplink messages via the set of multiple subbands using the set of multiple subband-specific transmit powers obtained from the set of multiple uplink power control procedures.

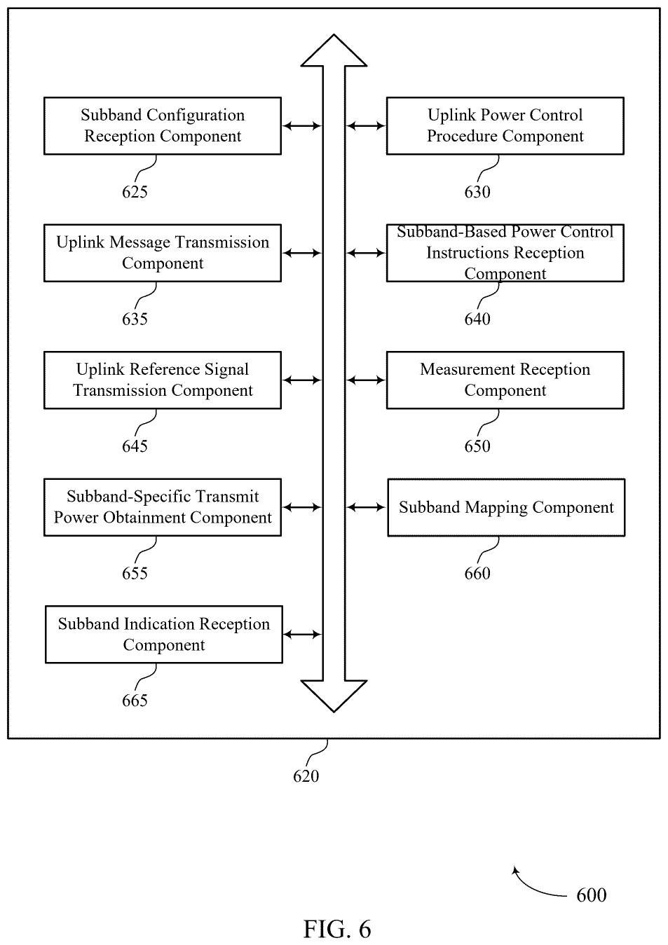

FIG. 6 shows a block diagram 600 of a communications manager 620 that supports subband-based uplink power control in accordance with one or more aspects of the present disclosure. The communications manager 620 may be an example of aspects of a communications manager 420, a communications manager 520, or both, as described herein. The communications manager 620, or various components thereof, may be an example of means for performing various aspects of subband-based uplink power control as described herein. For example, the communications manager 620 may include a subband configuration reception component 625, an uplink power control procedure component 630, an uplink message transmission component 635, a subband-based power control instructions reception component 640, an uplink reference signal transmission component 645, a measurement reception component 650, a subband-specific transmit power obtainment component 655, a subband mapping component 660, a subband indication reception component 665, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The subband configuration reception component 625 is capable of, configured to, or operable to support a means for receiving an indication of a subband configuration for an operating bandwidth of the UE, the subband configuration indicating a division of the operating bandwidth into a set of multiple subbands. The uplink power control procedure component 630 is capable of, configured to, or operable to support a means for performing a set of multiple uplink power control procedures for the set of multiple subbands to obtain a set of multiple subband-specific transmit powers for the set of multiple subbands. The uplink message transmission component 635 is capable of, configured to, or operable to support a means for transmitting one or more uplink messages via the set of multiple subbands using the set of multiple subband-specific transmit powers obtained from the set of multiple uplink power control procedures.

In some examples, the subband-based power control instructions reception component 640 is capable of, configured to, or operable to support a means for receiving instructions to perform subband-based power control for uplink, where the set of multiple uplink power control procedures is performed based on the instructions to perform subband-based power control for uplink.

In some examples, to support performing the set of multiple uplink power control procedures, the uplink reference signal transmission component 645 is capable of, configured to, or operable to support a means for transmitting a set of multiple uplink reference signals via the set of multiple subbands. In some examples, to support performing the set of multiple uplink power control procedures, the measurement reception component 650 is capable of, configured to, or operable to support a means for receiving, from a network entity, an indication of a set of multiple measurements corresponding to the set of multiple reference signals (e.g., uplink reference signals). In some examples, to support performing the set of multiple uplink power control procedures, the subband-specific transmit power obtainment component 655 is capable of, configured to, or operable to support a means for obtaining the set of multiple subband-specific transmit powers for the set of multiple subbands based on the set of multiple measurements.

In some examples, to support receiving the indication of the set of multiple measurements, the measurement reception component 650 is capable of, configured to, or operable to support a means for receiving a set of multiple offsets for the set of multiple subbands, where the set of multiple subband-specific transmit powers is based on the set of multiple offsets.

In some examples, to support receiving the indication of the set of multiple measurements, the measurement reception component 650 is capable of, configured to, or operable to support a means for receiving, for the set of multiple subbands, a set of multiple offsets relative to a baseline offset, where the set of multiple subband-specific transmit powers is based on the set of multiple offsets and the baseline offset.

In some examples, the set of multiple measurements includes a set of multiple pathloss measurements corresponding to the set of multiple subbands and includes one or more parameters corresponds to the set of multiple subbands, the one or more parameters corresponding to subband-specific pathloss measurements associated with the network entity.

In some examples, to support receiving indication of the subband configuration, the subband configuration reception component 625 is capable of, configured to, or operable to support a means for receiving a quantity of subbands, an upper frequency of one or more of the set of multiple subbands, a lower frequency of one or more of the set of multiple subbands, a relative location of one or more of the set of multiple subbands based on one or more resources, one or more optical wireless communication (OWC) parameters of a network entity, one or more OWC parameters of the UE, or any combination thereof.

In some examples, the uplink reference signal transmission component 645 is capable of, configured to, or operable to support a means for transmitting a set of multiple uplink reference signals via the set of multiple subbands. In some examples, the measurement reception component 650 is capable of, configured to, or operable to support a means for receiving, from a network entity, an indication of a set of multiple uplink pathloss measurements corresponding to the set of multiple uplink reference signals. In some examples, to perform the set of multiple uplink power control procedures, the uplink power control procedure component 630 is capable of, configured to, or operable to support a means for performing, based on a mapping between the set of multiple uplink pathloss measurements and the set of multiple subbands, a first power control procedure for a first subband of the set of multiple subbands using a first uplink pathloss measurement of the set of multiple uplink pathloss measurements to obtain a first subband-specific transmit power for the first subband and the uplink power control procedure component 630 is capable of, configured to, or operable to support a means for performing, based on the mapping between the set of multiple uplink pathloss measurements and the set of multiple subbands, a second power control procedure for a second subband of the set of multiple subbands using a second uplink pathloss measurement of the set of multiple uplink pathloss measurements to obtain a second subband-specific transmit power for the second subband. In some examples, the mapping is specific to an uplink communication link direction.

In some examples, the subband mapping component 660 is capable of, configured to, or operable to support a means for mapping the set of multiple subbands to a set of multiple MCS factors. In some examples, the subband indication reception component 665 is capable of, configured to, or operable to support a means for receiving an indication identifying one or more subbands of the set of multiple subbands. In some examples, the uplink message transmission component 635 is capable of, configured to, or operable to support a means for transmitting one or more additional uplink messages via the identified one or more subbands of the set of multiple subbands based on one or more corresponding MCS factors of the set of multiple MCS factors.

In some examples, the subband mapping component 660 is capable of, configured to, or operable to support a means for mapping the set of multiple subbands to a set of multiple resource block factors. In some examples, the subband indication reception component 665 is capable of, configured to, or operable to support a means for receiving an indication identifying one or more subbands of the set of multiple subbands. In some examples, the uplink message transmission component 635 is capable of, configured to, or operable to support a means for transmitting one or more additional uplink messages via the identified one or more subbands of the set of multiple subbands based on one or more corresponding resource block factors of the set of multiple resource block factors.

In some examples, the measurement reception component 650 is capable of, configured to, or operable to support a means for receiving, from a network entity, a first indication of one or more target receive powers for the network entity. In some examples, the subband mapping component 660 is capable of, configured to, or operable to support a means for mapping the set of multiple subbands to the one or more target receive powers. In some examples, the subband indication reception component 665 is capable of, configured to, or operable to support a means for receiving a second indication identifying one or more subbands of the set of multiple subbands. In some examples, the uplink message transmission component 635 is capable of, configured to, or operable to support a means for transmitting one or more additional uplink messages via the identified one or more subbands based on the one or more target receive powers.

In some examples, the subband mapping component 660 is capable of, configured to, or operable to support a means for mapping the set of multiple subbands to a set of multiple power control parameters. In some examples, the subband indication reception component 665 is capable of, configured to, or operable to support a means for receiving an indication identifying one or more subbands of the set of multiple subbands. In some examples, the uplink message transmission component 635 is capable of, configured to, or operable to support a means for transmitting one or more additional uplink messages via the identified one or more subbands of the set of multiple subbands based on a corresponding one or more power control parameters of the set of multiple power control parameters.

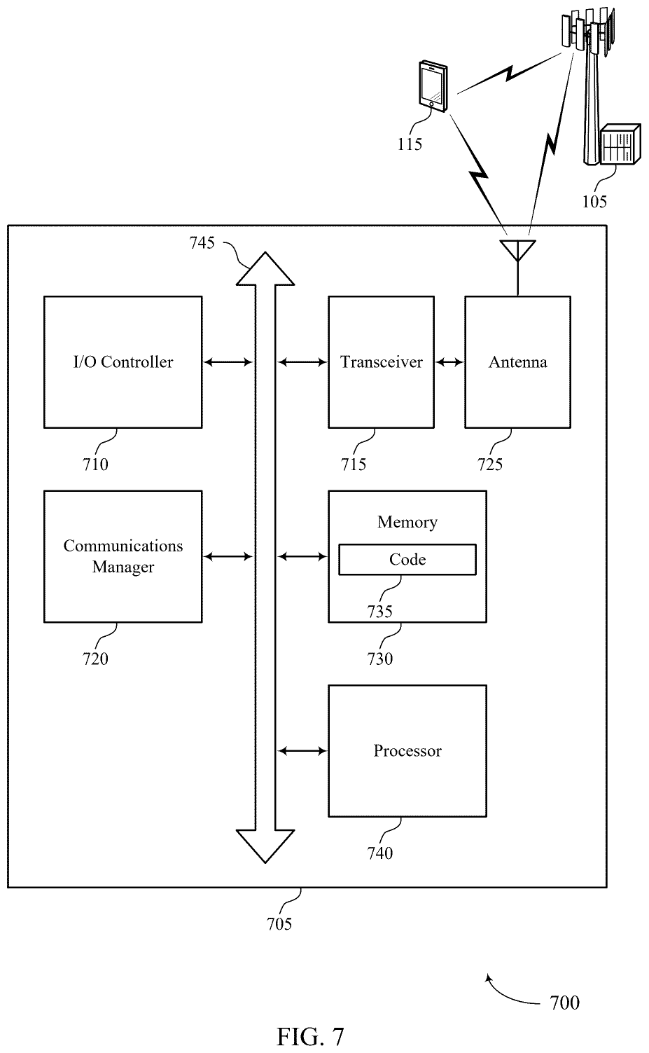

FIG. 7 shows a diagram of a system 700 including a device 705 that supports subband-based uplink power control in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting subband-based uplink power control). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving an indication of a subband configuration for an operating bandwidth of the UE, the subband configuration indicating a division of the operating bandwidth into a set of multiple subbands. The communications manager 720 is capable of, configured to, or operable to support a means for performing a set of multiple uplink power control procedures for the set of multiple subbands to obtain a set of multiple subband-specific transmit powers for the set of multiple subbands. The communications manager 720 is capable of, configured to, or operable to support a means for transmitting one or more uplink messages via the set of multiple subbands using the set of multiple subband-specific transmit powers obtained from the set of multiple uplink power control procedures.

By including or configuring the communications manager 720 in accordance with examples as described herein, the device 705 may support techniques for subband-based uplink power control, which may result in various advantageous, including improved communication reliability, reduced latency, improved user experience related to reduced processing, reduced power consumption, more efficient utilization of communication resources, improved coordination between devices, longer battery life, improved utilization of processing capability, etc.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of subband-based uplink power control as described herein, or the at least one processor 740 and the at least one memory 730 may be otherwise configured to, individually or collectively, perform or support such operations.

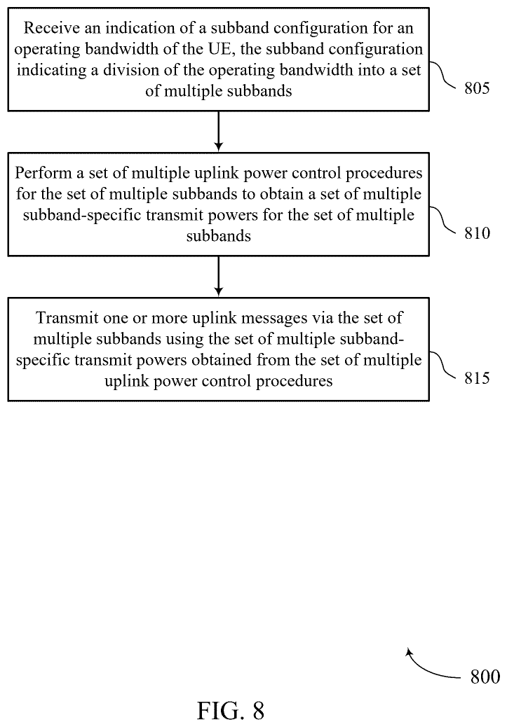

FIG. 8 shows a flowchart illustrating a method 800 that supports subband-based uplink power control in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving an indication of a subband configuration for an operating bandwidth of the UE, the subband configuration indicating a division of the operating bandwidth into a set of multiple subbands. The operations of 805 may be performed in accordance with examples as disclosed herein. In some examples, aspects of the operations of 805 may be performed by a subband configuration reception component 625 as described with reference to FIG. 6.

At 810, the method may include performing a set of multiple uplink power control procedures for the set of multiple subbands to obtain a set of multiple subband-specific transmit powers for the set of multiple subbands. The operations of 810 may be performed in accordance with examples as disclosed herein. In some examples, aspects of the operations of 810 may be performed by an uplink power control procedure component 630 as described with reference to FIG. 6.

At 815, the method may include transmitting one or more uplink messages via the set of multiple subbands using the set of multiple subband-specific transmit powers obtained from the set of multiple uplink power control procedures. The operations of 815 may be performed in accordance with examples as disclosed herein. In some examples, aspects of the operations of 815 may be performed by an uplink message transmission component 635 as described with reference to FIG. 6.

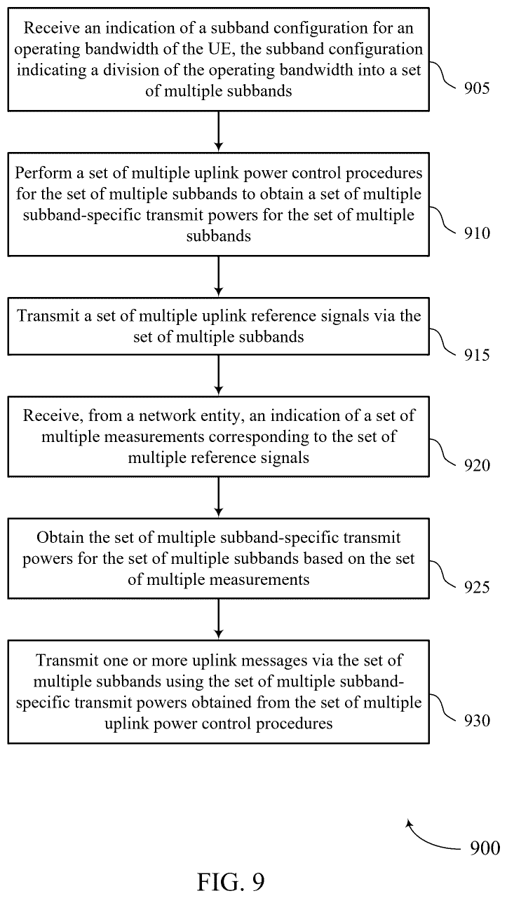

FIG. 9 shows a flowchart illustrating a method 900 that supports subband-based uplink power control in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving an indication of a subband configuration for an operating bandwidth of the UE, the subband configuration indicating a division of the operating bandwidth into a set of multiple subbands. The operations of 905 may be performed in accordance with examples as disclosed herein. In some examples, aspects of the operations of 905 may be performed by a subband configuration reception component 625 as described with reference to FIG. 6.

At 910, the method may include performing a set of multiple uplink power control procedures for the set of multiple subbands to obtain a set of multiple subband-specific transmit powers for the set of multiple subbands. The operations of 910 may be performed in accordance with examples as disclosed herein. In some examples, aspects of the operations of 910 may be performed by an uplink power control procedure component 630 as described with reference to FIG. 6.

At 915, the method may include transmitting a set of multiple uplink reference signals via the set of multiple subbands. The operations of 915 may be performed in accordance with examples as disclosed herein. In some examples, aspects of the operations of 915 may be performed by an uplink reference signal transmission component 645 as described with reference to FIG. 6.

At 920, the method may include receiving, from a network entity, an indication of a set of multiple measurements corresponding to the set of multiple reference signals. The operations of 920 may be performed in accordance with examples as disclosed herein. In some examples, aspects of the operations of 920 may be performed by a measurement reception component 650 as described with reference to FIG. 6.

At 925, the method may include obtaining the set of multiple subband-specific transmit powers for the set of multiple subbands based on the set of multiple measurements. The operations of 925 may be performed in accordance with examples as disclosed herein. In some examples, aspects of the operations of 925 may be performed by a subband-specific transmit power obtainment component 655 as described with reference to FIG. 6.

At 930, the method may include transmitting one or more uplink messages via the set of multiple subbands using the set of multiple subband-specific transmit powers obtained from the set of multiple uplink power control procedures. The operations of 930 may be performed in accordance with examples as disclosed herein. In some examples, aspects of the operations of 930 may be performed by an uplink message transmission component 635 as described with reference to FIG. 6.

The following provides an overview of aspects of the present disclosure:
Aspect 1: A method for wireless communications at a UE, comprising: receiving an indication of a subband configuration for an operating bandwidth of the UE, the subband configuration indicating a division of the operating bandwidth into a plurality of subbands; performing a plurality of uplink power control procedures for the plurality of subbands to obtain a plurality of subband-specific transmit powers for the plurality of subbands; and transmitting one or more uplink messages via the plurality of subbands using the plurality of subband-specific transmit powers obtained from the plurality of uplink power control procedures.
Aspect 2: The method of aspect 1, further comprising: receiving instructions to perform subband-based power control for uplink, wherein the plurality of uplink power control procedures is performed based at least in part on the instructions to perform subband-based power control for uplink.
Aspect 3: The method of any of aspects 1 through 2, wherein performing the plurality of uplink power control procedures comprises: transmitting a plurality of uplink reference signals via the plurality of subbands; receiving, from a network entity, an indication of a plurality of measurements corresponding to the plurality of reference signals (e.g., uplink reference signals); and obtaining the plurality of subband-specific transmit powers for the plurality of subbands based at least in part on the plurality of measurements.
Aspect 4: The method of aspect 3, wherein receiving the indication of the plurality of measurements comprises: receiving a plurality of offsets for the plurality of subbands, wherein the plurality of subband-specific transmit powers is based at least in part on the plurality of offsets.
Aspect 5: The method of any of aspects 3 through 4, wherein receiving the indication of the plurality of measurements comprises: receiving, for the plurality of subbands, a plurality of offsets relative to a baseline offset, wherein the plurality of subband-specific transmit powers is based at least in part on the plurality of offsets and the baseline offset.
Aspect 6: The method of any of aspects 3 through 5, wherein the plurality of measurements comprises a plurality of pathloss measurements corresponding to the plurality of subbands and comprises one or more parameters corresponds to the plurality of subbands, the one or more parameters corresponding to subband-specific pathloss measurements associated with the network entity.
Aspect 7: The method of any of aspects 1 through 6, wherein receiving indication of the subband configuration comprises: receiving a quantity of subbands, an upper frequency of one or more of the plurality of subbands, a lower frequency of one or more of the plurality of subbands, a relative location of one or more of the plurality of subbands based at least in part on one or more resources, one or more OWC parameters of a network entity, one or more OWC parameters of the UE, or any combination thereof.
Aspect 8: The method of any of aspects 1 through 7, further comprising: transmitting a plurality of uplink reference signals via the plurality of subbands; and receiving, from a network entity, an indication of a plurality of uplink pathloss measurements corresponding to the plurality of uplink reference signals, wherein performing the plurality of uplink power control procedures comprises: performing, based at least in part on a mapping between the plurality of uplink pathloss measurements and the plurality of subbands, a first power control procedure for a first subband of the plurality of subbands using a first uplink pathloss measurement of the plurality of uplink pathloss measurements to obtain a first subband-specific transmit power for the first subband; and performing, based at least in part on the mapping between the plurality of uplink pathloss measurements and the plurality of subbands, a second power control procedure for a second subband of the plurality of subbands using a second uplink pathloss measurement of the plurality of uplink pathloss measurements to obtain a second subband-specific transmit power for the second subband.
Aspect 9: The method of aspect 8, wherein the mapping is specific to an uplink communication link direction.
Aspect 10: The method of any of aspects 1 through 9, further comprising: mapping the plurality of subbands to a plurality of MCS factors; receiving an indication identifying one or more subbands of the plurality of subbands; and transmitting one or more additional uplink messages via the identified one or more subbands of the plurality of subbands based at least in part on one or more corresponding MCS factors of the plurality of MCS factors.
Aspect 11: The method of any of aspects 1 through 10, further comprising: mapping the plurality of subbands to a plurality of resource block factors; receiving an indication identifying one or more subbands of the plurality of subbands; and transmitting one or more additional uplink messages via the identified one or more subbands of the plurality of subbands based at least in part on one or more corresponding resource block factors of the plurality of resource block factors.
Aspect 12: The method of any of aspects 1 through 11, further comprising: receiving, from a network entity, a first indication of one or more target receive powers for the network entity; mapping the plurality of subbands to the one or more target receive powers; receiving a second indication identifying one or more subbands of the plurality of subbands; and transmitting one or more additional uplink messages via the identified one or more subbands based at least in part on the one or more target receive powers.
Aspect 13: The method of any of aspects 1 through 12, further comprising: mapping the plurality of subbands to a plurality of power control parameters; receiving an indication identifying one or more subbands of the plurality of subbands; and transmitting one or more additional uplink messages via the identified one or more subbands of the plurality of subbands based at least in part on a corresponding one or more power control parameters of the plurality of power control parameters.
Aspect 14: A UE for wireless communications, comprising one or more memories storing processor-executable code, and one or more processors coupled with the one or more memories and individually or collectively operable to execute the code to cause the UE to perform a method of any of aspects 1 through 13.
Aspect 15: A UE for wireless communications, comprising at least one means for performing a method of any of aspects 1 through 13.
Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive an indication of a subband configuration for an operating bandwidth of the UE, the subband configuration indicating a division of the operating bandwidth into a plurality of subbands;
perform a plurality of uplink power control procedures for the plurality of subbands to obtain a plurality of subband-specific transmit powers for the plurality of subbands; and
transmit one or more uplink messages via the plurality of subbands using the plurality of subband-specific transmit powers obtained from the plurality of uplink power control procedures.

2. The UE of claim 1, wherein the one or more processors are individually or collectively further operable to execute the code to cause the UE to:
receive instructions to perform subband-based power control for uplink, wherein the plurality of uplink power control procedures is performed based at least in part on the instructions to perform subband-based power control for uplink.

3. The UE of claim 1, wherein, to perform the plurality of uplink power control procedures, the one or more processors are individually or collectively operable to execute the code to cause the UE to:
transmit a plurality of uplink reference signals via the plurality of subbands;
receive, from a network entity, an indication of a plurality of measurements corresponding to the plurality of uplink reference signals; and
obtain the plurality of subband-specific transmit powers for the plurality of subbands based at least in part on the plurality of measurements.

4. The UE of claim 3, wherein, to receive the indication of the plurality of measurements, the one or more processors are individually or collectively operable to execute the code to cause the UE to:
receive a plurality of offsets for the plurality of subbands, wherein the plurality of subband-specific transmit powers is based at least in part on the plurality of offsets.

5. The UE of claim 3, wherein, to receive the indication of the plurality of measurements, the one or more processors are individually or collectively operable to execute the code to cause the UE to:
receive, for the plurality of subbands, a plurality of offsets relative to a baseline offset, wherein the plurality of subband-specific transmit powers is based at least in part on the plurality of offsets and the baseline offset.

6. The UE of claim 3, wherein the plurality of measurements comprises a plurality of pathloss measurements corresponding to the plurality of subbands and comprises one or more parameters corresponds to the plurality of subbands, the one or more parameters corresponding to subband-specific pathloss measurements associated with the network entity.

7. The UE of claim 1, wherein, to receive the indication of the subband configuration, the one or more processors are individually or collectively operable to execute the code to cause the UE to:
receive a quantity of subbands, an upper frequency of one or more of the plurality of subbands, a lower frequency of one or more of the plurality of subbands, a relative location of one or more of the plurality of subbands based at least in part on one or more resources, one or more optical wireless communication (OWC) parameters of a network entity, one or more OWC parameters of the UE, or any combination thereof.

8. The UE of claim 1, wherein the one or more processors are individually or collectively further operable to execute the code to cause the UE to:
transmit a plurality of uplink reference signals via the plurality of subbands; and
receive, from a network entity, an indication of a plurality of uplink pathloss measurements corresponding to the plurality of uplink reference signals, wherein, to perform the plurality of uplink power control procedures, the one or more processors are individually or collectively operable to execute the code to cause the UE to:
perform, based at least in part on a mapping between the plurality of uplink pathloss measurements and the plurality of subbands, a first power control procedure for a first subband of the plurality of subbands using a first uplink pathloss measurement of the plurality of uplink pathloss measurements to obtain a first subband-specific transmit power for the first subband; and
perform, based at least in part on the mapping between the plurality of uplink pathloss measurements and the plurality of subbands, a second power control procedure for a second subband of the plurality of subbands using a second uplink pathloss measurement of the plurality of uplink pathloss measurements to obtain a second subband-specific transmit power for the second subband.

9. The UE of claim 8, wherein the mapping is specific to an uplink communication link direction.

10. The UE of claim 1, wherein the one or more processors are individually or collectively further operable to execute the code to cause the UE to:
map the plurality of subbands to a plurality of modulation and coding scheme (MCS) index factors;
receive an indication identifying one or more subbands of the plurality of subbands; and
transmit one or more additional uplink messages via the identified one or more subbands of the plurality of subbands based at least in part on one or more corresponding MCS factors of the plurality of MCS factors.

11. The UE of claim 1, wherein the one or more processors are individually or collectively further operable to execute the code to cause the UE to:
map the plurality of subbands to a plurality of resource block factors;
receive an indication identifying one or more subbands of the plurality of subbands; and
transmit one or more additional uplink messages via the identified one or more subbands of the plurality of subbands based at least in part on one or more corresponding resource block factors of the plurality of resource block factors.

12. The UE of claim 1, wherein the one or more processors are individually or collectively further operable to execute the code to cause the UE to:
receive, from a network entity, a first indication of one or more target receive powers for the network entity;
map the plurality of subbands to the one or more target receive powers;
receive a second indication identifying one or more subbands of the plurality of subbands; and
transmit one or more additional uplink messages via the identified one or more subbands based at least in part on the one or more target receive powers.

13. The UE of claim 1, wherein the one or more processors are individually or collectively further operable to execute the code to cause the UE to:
map the plurality of subbands to a plurality of power control parameters;
receive an indication identifying one or more subbands of the plurality of subbands; and
transmit one or more additional uplink messages via the identified one or more subbands of the plurality of subbands based at least in part on a corresponding one or more power control parameters of the plurality of power control parameters.

14. A method for wireless communications at a user equipment (UE), comprising:
receiving an indication of a subband configuration for an operating bandwidth of the UE, the subband configuration indicating a division of the operating bandwidth into a plurality of subbands;
performing a plurality of uplink power control procedures for the plurality of subbands to obtain a plurality of subband-specific transmit powers for the plurality of subbands; and
transmitting one or more uplink messages via the plurality of subbands using the plurality of subband-specific transmit powers obtained from the plurality of uplink power control procedures.

15. The method of claim 14, further comprising:
receiving instructions to perform subband-based power control for uplink, wherein the plurality of uplink power control procedures is performed based at least in part on the instructions to perform subband-based power control for uplink.

16. The method of claim 14, wherein performing the plurality of uplink power control procedures comprises:
transmitting a plurality of uplink reference signals via the plurality of subbands;
receiving, from a network entity, an indication of a plurality of measurements corresponding to the plurality of uplink reference signals; and
obtaining the plurality of subband-specific transmit powers for the plurality of subbands based at least in part on the plurality of measurements.

17. The method of claim 16, wherein receiving the indication of the plurality of measurements comprises:
receiving a plurality of offsets for the plurality of subbands, wherein the plurality of subband-specific transmit powers is based at least in part on the plurality of offsets.

18. The method of claim 16, wherein receiving the indication of the plurality of measurements comprises:
receiving, for the plurality of subbands, a plurality of offsets relative to a baseline offset, wherein the plurality of subband-specific transmit powers is based at least in part on the plurality of offsets and the baseline offset.

19. The method of claim 16, wherein the plurality of measurements comprises a plurality of pathloss measurements corresponding to the plurality of subbands and comprises one or more parameters corresponds to the plurality of subbands, the one or more parameters corresponding to subband-specific pathloss measurements associated with the network entity.

20. A user equipment (UE), comprising:
means for receiving an indication of a subband configuration for an operating bandwidth of the UE, the subband configuration indicating a division of the operating bandwidth into a plurality of subbands;
means for performing a plurality of uplink power control procedures for the plurality of subbands to obtain a plurality of subband-specific transmit powers for the plurality of subbands; and
means for transmitting one or more uplink messages via the plurality of subbands using the plurality of subband-specific transmit powers obtained from the plurality of uplink power control procedures.
